(19) United States
(12) Patent Application Publication
(10) Pub. No.: US 2016/0115029 A1
(43) Pub. Date: Apr. 28, 2016

(54) HELIUM RECOVERY PROCESS AND APPARATUS

(71) Applicant: UOP LLC, Des Plaines, IL (US)

(72) Inventors: Manu G. R. Van Leuvenhaege, Antwerp (BE); Cedric F. Vercammen, Antwerp (BE); Pavel V. Ryabchenko, Moscow (RU)

(21) Appl. No.: 14/919,816

(22) Filed: Oct. 22, 2015

(30) Foreign Application Priority Data
Oct. 27, 2014 (RU) 2014143204

(51) Int. Cl. C01B 23/00; B01D 53/22; B01D 53/047

(52) U.S. Cl. CPC C01B 23/0094; B01D 53/047; B01D 53/229; B01D 2256/18; B01D 2257/504; B01D 2257/80; C01B 2210/0031; C01B 2210/0004; C01B 2210/0014; C01B 2210/001

(57) ABSTRACT

A process and apparatus for increasing recovery of helium are described. The process includes introducing the stream containing helium and at least one oxidizable component into an oxidation zone in the presence of oxygen to oxidize the oxidizable component forming a first vapor stream and a first liquid stream. The first vapor stream is introduced into a pressure swing adsorption zone to form a purified helium stream and a tail gas stream. The tail gas stream is compressed. The compressed tail gas stream is introduced into a membrane separation zone to form a helium rich permeate stream and a retentate stream. The helium rich permeate stream is compressed and introduced into the oxidation system.

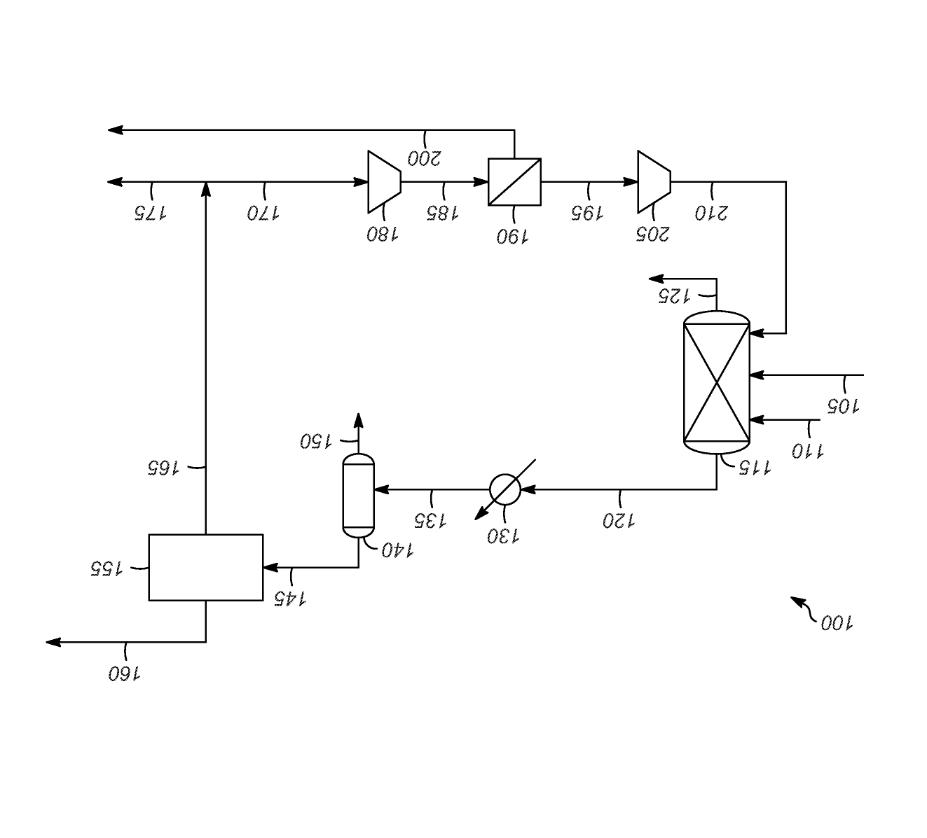

### CROSS-REFERENCE TO RELATED APPLICATION

This application claims priority from Russian Application No. 2014143204 filed Oct. 27, 2014, the contents of which are hereby incorporated by reference.

### BACKGROUND OF THE INVENTION

Various processes are used to recover helium from gas streams. One of the most common processes is the cryogenic distillation process. Cryogenic distillation provides high recovery of helium. Membrane separation has also been used for helium recovery. Pressure swing adsorption (PSA) processes have also been used.

The recovery of helium from a process stream using PSA processes is typically limited to about 75-80%, which means that about 20-25% of the helium is being lost. The rate can be improved slightly by recycling some of the PSA tail gas. However, the improvement in recovery is limited because recycling more tail gas, which has a low level of helium, lowers the helium concentration in the PSA feed gas, resulting in lower recovery in the PSA system itself.

There is a need for improved processes which provide high recovery of helium from process streams containing hydrogen.

### SUMMARY OF THE INVENTION

One aspect of the present invention is a process of increasing recovery of helium from a stream containing helium. In one embodiment, the process includes introducing the stream containing helium and at least one oxidizable component into an oxidation zone in the presence of oxygen to oxidize the at least one oxidizable component forming a first vapor stream and a first liquid stream. At least a portion of the first vapor stream is introduced into a pressure swing adsorption zone to form a purified helium stream and a tail gas stream, the tail gas stream containing helium. At least a portion of the tail gas stream is compressed. At least a portion of the compressed tail gas stream is introduced into a membrane separation zone to form a helium rich permeate stream and a retentate stream. At least a portion of the helium rich permeate stream is compressed. The compressed helium rich permeate stream is introduced into the oxidation system.

Another aspect of the invention is an apparatus for recovery of helium from a stream containing helium. The apparatus includes an oxidation zone having a feed inlet, an oxygen inlet, a liquid outlet, and a gas outlet; a condenser having an inlet and an outlet, the inlet of the condenser being in fluid communication with the gas outlet of the oxidation zone; a separator having an inlet, a liquid outlet, and a gas outlet, the inlet of the separator in fluid communication with the outlet of the condenser; a pressure swing adsorption zone having an inlet, a purified helium outlet, and a tail gas outlet, the inlet of the pressure swing adsorption zone being in fluid communication with the outlet of the separator; a first compressor having an inlet and an outlet, the inlet of the first compressor being in fluid communication with the tail gas outlet of the pressure swing adsorption system; a membrane separation zone having an inlet, a permeate outlet, and a retentate outlet, the inlet of the membrane separation zone being in fluid communication with the tail gas outlet of the pressure swing adsorption zone; and a second compressor having an inlet and an outlet, the inlet of the second compressor being in fluid communication with the permeate outlet of the membrane separation zone, and the outlet of the second compressor being in fluid communication with the oxidation zone.

### BRIEF DESCRIPTION OF THE DRAWING

The FIGURE illustrates one embodiment of a process of the present invention.

### DETAILED DESCRIPTION OF THE INVENTION

The present invention provides an improved process of helium recovery from a gas stream.

The process involves the use of an oxidation zone, a PSA zone, and a membrane separation zone. Oxidizable components in the feed are oxidized in the oxidation zone. The gas stream is sent to the PSA zone where purified helium is separated out. The PSA tail gas is sent to a membrane separation zone where a helium rich stream is formed. The helium rich stream, which contains a higher concentration of helium than the feed can be recycled without having a negative effect on the helium recovery in the PSA zone.

As shown in the FIGURE, the process 100 involves the introduction of a gas stream 105 containing helium. In addition to helium, stream 105 can include, but is not limited to, one or more of hydrogen, methane, carbon monoxide, carbon dioxide, nitrogen, argon, and other noble gases, for example. The source of the gas stream 105 can be for example, a natural gas stream or a natural gas stream that has been converted to a hydrogen stream. Either or both could be upgraded in helium concentration by another process system upstream. The feed stream will typically contain about 50-90 vol % helium, or about 55-60 vol %.

The gas stream 105 and an oxygen stream 110 are introduced into an oxidation zone 115. The gas stream 105 and the oxygen stream 110 can be introduced into the oxidation zone 115 either separately, as shown, or they can be mixed together prior to being introduced into the reaction zone. The oxygen stream is desirably purified oxygen, but streams containing less oxygen including air could also be used. Desirably, the oxygen stream contains more than about 50% oxygen, or more than about 60%, or more than about 70%, or more than about 80%, or more than about 85%, or more than about 90%, or more than about 95%, or more than about 97%, or more than about 99%.

The gas stream 105 contains oxidizable compounds, including, but not limited to, hydrogen, CH₄, ethane, and propane, carbon monoxide and the like. The oxidizable compounds are oxidized in the oxidation zone 115. The oxidation reaction forms a first vapor stream 120 and a liquid stream 125. The first vapor stream 120 comprises helium, water, carbon monoxide, carbon dioxide, and very low levels (in the ppm range) of hydrogen and hydrocarbons. The liquid stream 125 comprises water, which is removed from the system.

The oxidizable compounds are oxidized in the oxidation zone 115. For example, hydrogen is converted to water, hydrocarbons to carbon dioxide, carbon monoxide to carbon dioxide, etc. The oxidation zone can be any oxidation zone known to those of skill in the art. Suitable oxidation zones include, but are not limited to, burner systems, and catalytic oxidation zones.

The first vapor stream 120 is sent to a condenser 130 to cool and condense the first vapor stream 120. The condensed stream 135 is set to a separator 140, for example a filter coalescer, or other type of separator. The condensed stream 135 is separated into a second vapor stream 145 and a second liquid stream 150. The second vapor stream 145 comprises helium, carbon monoxide, carbon dioxide, and very low levels (in the ppm range) of hydrogen and hydrocarbons and a lower level of water than first vapor stream 120. The second liquid stream 150 comprises water.

The second vapor stream 145 is introduced into a PSA zone 155 for purification. In operation, the second vapor stream 145 is introduced into a packed bed, and the adsorbent material contained therein removes hydrocarbons, water, residual helium, and carbon dioxide, known as the sorbate, from the stream as it flows through the packed bed. After a given time period, the adsorbent material becomes saturated with the sorbate, and the adsorption process must be halted in order to regenerate the adsorbent and remove the sorbate. PSA processes utilize a de-pressurized regeneration gas that is introduced to the packed bed in a direction reverse to the flow of the process stream. After a regeneration cycle is complete, a new adsorption cycle can begin. Typical purities for PSA helium product streams range from 99 to 99.999% by volume.

Packed beds of adsorbent materials are typically used in PSA processes. The adsorbent materials are generally in the form of spherical beads, or extruded pellets. Alternatively, it may be shaped into honeycomb monolithic structures. The adsorbent may comprise powdered solid, crystalline or amorphous compounds capable of adsorbing and desorbing the adsorbable compound. Examples of such adsorbents include silica gels, activated aluminas, activated carbon, molecular sieves, and mixtures thereof. Molecular sieves include zeolite molecular sieves. The adsorbent materials are typically zeolites. In a processing scheme such as the one depicted in the FIGURE, the PSA unit 155 is typically operated at feed pressures ranging from about 1.0 MPa (g) to about 8.6 MPa (g).

Generally, such PSA units operate on a cyclic basis, with individual adsorber vessels cycled between adsorption and desorption steps. Multiple adsorbers are commonly used in order to provide constant product and tail gas flows. Adsorbents are selected based on the type and quantity of impurities present in the feed stream and also the required degree of removal of such impurities. Such PSA units and their operation are more fully described, for example, in U.S. Pat. Nos. 4,964,888 and 6,210,466, for example.

The purified helium 160 is sent for recovery. The tail gas stream 165 typically contains about 30-60% helium, or about 30-35%. It is typically at a pressure of about 130 kPa to about 500 kPa. The tail gas stream can be divided into stream 170 and stream 175. Stream 175 can be a purge stream to avoid the build-up various components in the system.

Stream 170 is then sent to a compression zone 180 where it is compressed to about 3 MPa. The compressed stream 185 is sent to the membrane separation zone (190). Membrane-based technologies have a low capital cost, and they provide high energy efficiency compared to conventional separation methods.

Polymers provide a range of properties including low cost, permeability, mechanical stability, and ease of processability that are important for gas separation. Glassy polymers (i.e., polymers at temperatures below their TO have stiffer polymer backbones and therefore allow smaller molecules such as hydrogen and helium pass through more quickly, while larger molecules such as hydrocarbons pass through more slowly as compared to polymers with less stiff backbones. Cellulose acetate (CA) glassy polymer membranes are used extensively in gas separation. Currently, such CA membranes are used for natural gas upgrading, including the removal of carbon dioxide. Although CA membranes have many advantages, they are limited in a number of properties including selectivity, permeability, and in chemical, thermal, and mechanical stability. High performance polymers such as polyimides (PIs), poly(trimethylsilylpropyne), and polytriazole have been developed to improve membrane selectivity, permeability, and thermal stability. These polymeric membrane materials have shown promising intrinsic properties for separation of gas pairs such as CO₂/CH₄, O₂/N₂, H₂/CH₄, and propylene/propane (C₃H₆/C₃H₈).

The membranes most commonly used in commercial gas and liquid separation applications are asymmetric polymeric membranes which have a thin nonporous selective skin layer that performs the separation. Separation is based on a solution-diffusion mechanism. This mechanism involves molecular-scale interactions of the permeating gas with the membrane polymer. The mechanism assumes that in a membrane having two opposing surfaces, each component is sorbed by the membrane at one surface, transported by a gas concentration gradient, and desorbed at the opposing surface. According to this solution-diffusion model, the membrane performance in separating a given pair of gases (e.g., CO₂/CH₄, O₂/N₂, H₂/CH₄,) is determined by two parameters: the permeability coefficient (abbreviated hereinafter as permeability or P_{A}) and the selectivity (α_{A/B}). The P_{A} is the product of the gas flux and the selective skin layer thickness of the membrane, divided by the pressure difference across the membrane. The α_{A/B} is the ratio of the permeability coefficients of the two gases (α_{A/B}=P_{A}/P_{B}) where P_{A} is the permeability of the more permeable gas and P_{A} is the permeability of the less permeable gas. Gases can have high permeability coefficients because of a high solubility coefficient, a high diffusion coefficient, or because both coefficients are high. In general, the diffusion coefficient decreases while the solubility coefficient increases with an increase in the molecular size of the gas. In high performance polymer membranes, both high permeability and selectivity are desirable because higher permeability decreases the size of the membrane area required to treat a given volume of gas, thereby decreasing capital cost of membrane units, and because higher selectivity results in a higher purity product gas.

One of the components to be separated by a membrane must have a sufficiently high permeance at the preferred conditions or an extraordinarily large membrane surface area is required to allow separation of large amounts of material. Permeance, measured in Gas Permeation Units (GPU, 1 GPU=10-6 cm³ (STP)/cm² s (cm Hg)), is the pressure normalized flux and equals to permeability divided by the skin layer thickness of the membrane. Commercially available gas separation polymer membranes, such as CA, polyimide, and polysulfone membranes formed by phase inversion and solvent exchange methods have an asymmetric integrally skinned membrane structure. Such membranes are characterized by a thin, dense, selectively semipermeable surface “skin” and a less dense void-containing (or porous), non-selective support region, with pore sizes ranging from large in the support region to very small proximate to the “skin.” Another type of commercially available gas separation polymer membrane is the thin film composite (or TFC) membrane, comprising a thin selective skin deposited on a porous support. TFC membranes can be formed from CA, polysulfone, polyethersulfone, polyamide, polyimide, polyetherimide, cellulose nitrate, polyurethane, polycarbonate, polystyrene, etc.

The compressed stream 185 is separated into permeate stream 195 and retentate stream 200 in membrane separation zone 190. Retentate stream 200, which will contain comprises helium, carbon monoxide, carbon dioxide, small amounts of water, and very low levels (in the ppm range) of hydrogen and hydrocarbons is removed from the system.

There is a significant pressure drop across the membrane. As a result, permeate stream 195 is compressed in compression zone 205 to a pressure of about 3 MPa to about 4 MPa. The compressed stream 210 is fed into the oxidation zone 115 along with feed 105 and oxygen stream 110. The compressed stream 210 can be fed into the oxidation zone separately, as shown, or it can be mixed with the feed 105 before entering the oxidation zone.

The compression zones 180 and 205 can be a single compressors, or there can be two or more compressors in either zone.

Alternatively, the tail gas stream 165 can be compressed in compression zone 180 before being divided into streams 170 and 175. If compression zone 180 includes more than one compressor, the tail gas stream 165 can be divided into streams 170 and 175 between the compressors in the compression zone 180.

In another alternative, the retentate stream 200 can be removed from the system after the compression zone 205. If compression zone 205 includes more than one compressor, the retentate stream 200 can be removed between the compressors in the compression zone 205.

In another alternative, a portion of the helium rich permeate stream 195 can be removed from the system before or after compression zone 205, or if compression zone 205 includes more than one compressor, the permeate stream 195 can be removed between the compressors in the compression zone 205. This can be done to avoid build-up of various components in the system.

### Example

A simulation was run making the following assumptions. The feed gas contains only hydrogen (10%), nitrogen (30%) and helium (60%). The oxygen stream is high purity oxygen (100.0%). The residual oxygen after oxidation is 1.0%. The assumed helium recovery of PSA is 75%. The targeted helium recovery is 98%. Table 1 is a material balance of a system reaching a helium recovery of 98% on a molar basis.

The streams are as follows:
105: Feed Stream (gas stream)
110: Oxygen Stream
120: Stream downstream of Oxidation (first vapor stream)
145: PSA Feed Stream (second vapor stream)
150: Liquid Condensate (second liquid stream)
160: Pure Helium Stream, ready for export (purified helium)
165: PSA Tail Gas to be compressed before membranes (tail gas stream)
175: Purge Stream from PSA Tail Gas: none
185: Membrane Feed gas stream (compressed stream)
200: Membrane Residue gas stream (leaves unit) (retentate stream)
210: Compressed Membrane Permeate Gas stream to be recycled to catalytic oxidation (compressed stream).

TABLE 1

| Stream | 105 | 110 | 120 | 145 | 150 | 160 | 165 | 175 | 185 | 200 | 210 |
|---|---|---|---|---|---|---|---|---|---|---|---|
| Pressure, MPa (abs) | 3.00 | 3.00 | 2.95 | 2.90 | 2.90 | 2.80 | 0.13 | | 3.00 | 2.80 | 3.00 |
| Temperature, ° C. | 40 | 40 | 830 | 40 | 40 | 38 | 38 | | 40 | 35 | 40 |
| Flow, Nm³/h | 10,000 | 585 | 12,192 | 11,220 | 972 | 5,879 | 5,341 | 0.0 | 5,323 | 3,207 | 2,106 |
| Composition, mole % | | | | | | | | | | | |
| Methane | 0.0 | 0.0 | 0.0 | 0.0 | 0.0 | 0.0 | 0.0 | | 0.0 | 0.0 | 0.0 |
| Nitrogen | 30.0 | 0.0 | 26.4 | 28.7 | 0.0 | 0.0 | 60.4 | | 60.6 | 93.6 | 10.7 |
| Water | 0.0 | 0.0 | 8.3 | 0.3 | 100.0 | 0.0 | 0.6 | | 0.3 | 0.0 | 0.3 |
| Helium | 60.0 | 0.0 | 64.3 | 69.9 | 0.0 | 100.0 | 36.7 | | 36.8 | 3.8 | 87.3 |
| Oxygen | 0.0 | 100.0 | 1.0 | 1.1 | 0.0 | 0.0 | 2.3 | | 2.3 | 2.7 | 1.7 |
| Hydrogen | 10.0 | 0.0 | 0.0 | 0.0 | 0.0 | 0.0 | 0.0 | | 0.0 | 0.0 | 0.0 |

By “about” we mean within 10% of the value, or within 5%, or within 1%.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

### Specific Embodiments

While the following is described in conjunction with specific embodiments, it will be understood that this description is intended to illustrate and not limit the scope of the preceding description and the appended claims.

A first embodiment of the invention is a process of increasing recovery of helium from a stream containing helium comprising introducing the stream containing helium and at least one oxidizable component into an oxidation zone in the presence of oxygen to oxidize the at least one oxidizable component forming a first vapor stream and a first liquid stream; introducing at least a portion of the first vapor stream into a pressure swing adsorption zone to form a purified helium stream and a tail gas stream, the tail gas stream containing helium; compressing at least a portion of the tail gas stream; introducing at least a portion of the compressed tail gas stream into a membrane separation zone to form a helium rich permeate stream and a retentate stream; compressing at least a portion of the helium rich permeate stream; and introducing the compressed helium rich permeate stream into the oxidation zone. An embodiment of the invention is one, any or all of prior embodiments in this paragraph up through the first embodiment in this paragraph further comprising condensing the first vapor stream before introducing the at least the portion of the first vapor stream into the pressure swing adsorption zone. An embodiment of the invention is one, any or all of prior embodiments in this paragraph up through the first embodiment in this paragraph further comprising separating the condensed first vapor stream into a second vapor stream and a second liquid stream; and wherein introducing the at least the portion of the first vapor stream into the pressure swing adsorption zone comprises introducing the second vapor stream into the pressure swing adsorption zone. An embodiment of the invention is one, any or all of prior embodiments in this paragraph up through the first embodiment in this paragraph wherein the oxidation zone comprises a catalytic oxidation zone. An embodiment of the invention is one, any or all of prior embodiments in this paragraph up through the first embodiment in this paragraph further comprising removing a portion of the tail gas stream. An embodiment of the invention is one, any or all of prior embodiments in this paragraph up through the first embodiment in this paragraph wherein the portion of the tail gas stream is removed before compressing the at least the portion of the tail gas stream. An embodiment of the invention is one, any or all of prior embodiments in this paragraph up through the first embodiment in this paragraph wherein the portion of the tail gas stream is removed after compressing the at least the portion of the tail gas stream. An embodiment of the invention is one, any or all of prior embodiments in this paragraph up through the first embodiment in this paragraph wherein the portion of the tail gas stream is removed after compressing the at least the portion of the helium rich permeate stream. An embodiment of the invention is one, any or all of prior embodiments in this paragraph up through the first embodiment in this paragraph further comprising removing a portion of the helium rich permeate gas stream. An embodiment of the invention is one, any or all of prior embodiments in this paragraph up through the first embodiment in this paragraph wherein the portion of the helium rich permeate gas stream is removed before compressing the at least the portion of the helium rich permeate gas stream. An embodiment of the invention is one, any or all of prior embodiments in this paragraph up through the first embodiment in this paragraph wherein the portion of the helium rich permeate stream is removed after compressing the at least the portion of the helium rich permeate stream. An embodiment of the invention is one, any or all of prior embodiments in this paragraph up through the first embodiment in this paragraph wherein the tail gas stream has a helium content of about 30-35%. An embodiment of the invention is one, any or all of prior embodiments in this paragraph up through the first embodiment in this paragraph wherein the helium rich permeate stream has a helium content of at least about 70%. An embodiment of the invention is one, any or all of prior embodiments in this paragraph up through the first embodiment in this paragraph wherein the stream containing helium has a helium content of about 50-90%, the tail gas stream has a helium content of about 30-60%, the helium rich permeate stream has a helium content of at least about 70%, and the purified helium stream has a helium content of at least about 99%.

A second embodiment of the invention is a process of increasing recovery of helium from a stream containing helium comprising introducing the stream containing helium into a catalytic oxidation zone in the presence of oxygen to oxidize the at least one oxidizable component forming a first vapor stream and a first liquid stream, wherein the stream containing helium has a helium content of about 55-60%; condensing the first vapor stream from the catalytic oxidation zone; separating the condensed first vapor stream into a second liquid stream and a second vapor stream; introducing the second vapor stream into a pressure swing adsorption zone to form a purified helium stream having a helium content of at least about 99% and a tail gas stream having a helium content of about 30-35%; compressing at least a portion of the tail gas stream; introducing at least a portion of the compressed tail gas stream into a membrane separation zone to form a helium rich permeate stream having a helium content of at least about 70% and a retentate stream; compressing the helium rich permeate stream; and introducing the compressed helium rich permeate stream into the catalytic oxidation zone. An embodiment of the invention is one, any or all of prior embodiments in this paragraph up through the second embodiment in this paragraph further comprising removing a portion of the tail gas stream. An embodiment of the invention is one, any or all of prior embodiments in this paragraph up through the second embodiment in this paragraph wherein the portion of the tail gas stream is removed before compressing the at least the portion of the tail gas stream. An embodiment of the invention is one, any or all of prior embodiments in this paragraph up through the second embodiment in this paragraph further comprising removing a portion of the helium rich permeate gas stream. An embodiment of the invention is one, any or all of prior embodiments in this paragraph up through the second embodiment in this paragraph wherein the portion of the helium rich permeate gas stream is removed before compressing the at least the portion of the helium rich permeate gas stream.

A third embodiment of the invention is an apparatus for recovery of helium from a stream containing helium comprising an oxidation zone having a feed inlet, an oxygen inlet, a liquid outlet, and a gas outlet; a condenser having an inlet and an outlet, the inlet of the condenser being in fluid communication with the gas outlet of the oxidation zone; a separator having an inlet, a liquid outlet, and a gas outlet, the inlet of the separator in fluid communication with the outlet of the condenser; a pressure swing adsorption zone having an inlet, a purified helium outlet, and a tail gas outlet, the inlet of the pressure swing adsorption zone being in fluid communication with the outlet of the separator; a first compression zone having an inlet and an outlet, the inlet of the first compression zone being in fluid communication with the tail gas outlet of the pressure swing adsorption system; a membrane separation zone having an inlet, a permeate outlet, and a retentate outlet, the inlet of the membrane separation zone being in fluid communication with the tail gas outlet of the pressure swing adsorption zone; and a second compression zone having an inlet and an outlet, the inlet of the second compression zone being in fluid communication with the permeate outlet of the membrane separation zone, and the outlet of the second compression zone being in fluid communication with the oxidation zone.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process of increasing recovery of helium from a stream containing helium comprising:
introducing the stream containing helium and at least one oxidizable component into an oxidation zone in the presence of oxygen to oxidize the at least one oxidizable component forming a first vapor stream and a first liquid stream;
introducing at least a portion of the first vapor stream into a pressure swing adsorption zone to form a purified helium stream and a tail gas stream, the tail gas stream containing helium;
compressing at least a portion of the tail gas stream;
introducing at least a portion of the compressed tail gas stream into a membrane separation zone to form a helium rich permeate stream and a retentate stream;
compressing at least a portion of the helium rich permeate stream; and
introducing the compressed helium rich permeate stream into the oxidation zone.

2. The process of claim 1 further comprising condensing the first vapor stream before introducing the at least the portion of the first vapor stream into the pressure swing adsorption zone.

3. The process of claim 2 further comprising:
separating the condensed first vapor stream into a second vapor stream and a second liquid stream; and
wherein introducing the at least the portion of the first vapor stream into the pressure swing adsorption zone comprises introducing the second vapor stream into the pressure swing adsorption zone.

4. The process of claim 1 wherein the oxidation zone comprises a catalytic oxidation zone.

5. The process of claim 1 further comprising removing a portion of the tail gas stream.

6. The process of claim 5 wherein the portion of the tail gas stream is removed before compressing the at least the portion of the tail gas stream.

7. The process of claim 5 wherein the portion of the tail gas stream is removed after compressing the at least the portion of the tail gas stream.

8. The process of claim 5 wherein the portion of the tail gas stream is removed after compressing the at least the portion of the helium rich permeate stream.

9. The process of claim 1 further comprising removing a portion of the helium rich permeate gas stream.

10. The process of claim 9 wherein the portion of the helium rich permeate gas stream is removed before compressing the at least the portion of the helium rich permeate gas stream.

11. The process of claim 9 wherein the portion of the helium rich permeate stream is removed after compressing the at least the portion of the helium rich permeate stream.

12. The process of claim 1 wherein the tail gas stream has a helium content of about 30-35%.

13. The process of claim 1 wherein the helium rich permeate stream has a helium content of at least about 70%.

14. The process of claim 1 wherein the stream containing helium has a helium content of about 50-90%, the tail gas stream has a helium content of about 30-60%, the helium rich permeate stream has a helium content of at least about 70%, and the purified helium stream has a helium content of at least about 99%.

15. A process of increasing recovery of helium from a stream containing helium comprising:
introducing the stream containing helium into a catalytic oxidation zone in the presence of oxygen to oxidize the at least one oxidizable component forming a first vapor stream and a first liquid stream, wherein the stream containing helium has a helium content of about 55-60%;
condensing the first vapor stream from the catalytic oxidation zone;
separating the condensed first vapor stream into a second liquid stream and a second vapor stream;
introducing the second vapor stream into a pressure swing adsorption zone to form a purified helium stream having a helium content of at least about 99% and a tail gas stream having a helium content of about 30-35%;
compressing at least a portion of the tail gas stream;
introducing at least a portion of the compressed tail gas stream into a membrane separation zone to form a helium rich permeate stream having a helium content of at least about 70% and a retentate stream;
compressing the helium rich permeate stream; and
introducing the compressed helium rich permeate stream into the catalytic oxidation zone.

16. The process of claim 15 further comprising removing a portion of the tail gas stream.

17. The process of claim 16 wherein the portion of the tail gas stream is removed before compressing the at least the portion of the tail gas stream.

18. The process of claim 15 further comprising removing a portion of the helium rich permeate gas stream.

19. The process of claim 18 wherein the portion of the helium rich permeate gas stream is removed before compressing the at least the portion of the helium rich permeate gas stream.

20. An apparatus for recovery of helium from a stream containing helium comprising:
an oxidation zone having a feed inlet, an oxygen inlet, a liquid outlet, and a gas outlet;
a condenser having an inlet and an outlet, the inlet of the condenser being in fluid communication with the gas outlet of the oxidation zone;
a separator having an inlet, a liquid outlet, and a gas outlet, the inlet of the separator in fluid communication with the outlet of the condenser;
a pressure swing adsorption zone having an inlet, a purified helium outlet, and a tail gas outlet, the inlet of the pressure swing adsorption zone being in fluid communication with the outlet of the separator;
a first compression zone having an inlet and an outlet, the inlet of the first compression zone being in fluid communication with the tail gas outlet of the pressure swing adsorption system;
a membrane separation zone having an inlet, a permeate outlet, and a retentate outlet, the inlet of the membrane separation zone being in fluid communication with the tail gas outlet of the pressure swing adsorption zone; and
a second compression zone having an inlet and an outlet, the inlet of the second compression zone being in fluid communication with the permeate outlet of the membrane separation zone, and the outlet of the second compression zone being in fluid communication with the oxidation zone.
